(19) United States
(12) Patent Application Publication
(10) Pub. No.: US 2001/0004063 A1
(43) Pub. Date: Jun. 21, 2001

(54) Apparatus for purifying wastewater

(75) Inventor: Young-Sik Oh, Seoul (KR)

Correspondence Address: NIXON PEABODY LLP, Clinton Square, P.O. Box 1051, Rochester, NY, 14603, US

(73) Assignee: Sung-Won E&T Co., Ltd.

(21) Appl. No.: 09/738,754

(22) Filed: Dec. 15, 2000

(30) Foreign Application Priority Data
Dec. 18, 1999 (KR) 1999-58994

(51) Int. Cl. C02F 1/00

(52) U.S. Cl. 210/748; 210/749; 210/750; 210/188; 210/198.1; 210/243

(57) ABSTRACT

The present invention provides an apparatus for purifying wastewater comprising a) a reaction tank which wastewater is introduced to and stays for a predetermined time; b) a circulation treatment apparatus comprising i) an electrolysis and electrocoagulation apparatus that is connected to wastewater inlet of the reaction tank, which wastewater is continuously introduced to, electrolyzed and electocoagulated; and ii) a mass transfer accelerator that dissolves gases self-produced in the electrolysis and electrocoagulation apparatus in treated water discharged from the electrolysis and electrocoagulation apparatus; and c) a sedimentation tank where treated water that overflows from the reaction tank stands, from which the resultant precipitates are removed.

### BACKGROUND OF THE INVENTION

(a) Field of the Invention

The present invention relates to an apparatus for purifying wastewater. Specifically, the present invention relates to an apparatus for purifying wastewater, which is useful for treating refractory and high concentration organic wastewater that can cause problems, such as land fill leachate, night soil, livestock wastes, wastes from chemical plants, etc. The apparatus can be easily installed for expanding existing wastewater treatment plants for improving the quality of effluent water, and can be further connected to a biological treatment.

(b) Description of the Related Art

Generally, a biological treatment method is employed to purify wastewater containing high density, refractory materials.

However, according to this treatment, total process time is very long because a long retention time in an aeration tank is required, and the removal of low-soluble materials by microorganisms is limited even if the retention time of wastewater in an aeration tank increases.

In addition, since the wastewater should be diluted with water or various chemicals should be introduced therein in order to improve the efficiency of removal of organic materials, there is a concern for generating secondary pollution due to the production of a large quantity of sludge, and for difficulty in operating the process.

In addition, the biological treatment requires a lot of facilities and thus facility costs and area of land required is high, and the quality of the biologically treated wastewater inevitably falls shorts of the standard level of the effluent water under current technology.

In areas where four seasons are clearly distinguished and temperature fluctuation is large, it is very difficult to culture and control microorganisms so as to maintain optimum conditions for them. Even for highly sophisticated technicians, it is difficult to culture microorganisms which are highly active and insensitive to the environment and to utilize them to purify wastewater. And when problems occur in the cultivation and control of microorganisms, abnormal effluent water is inevitably discharged for tens of days even if prompt measures are taken.

Accordingly, in order to promote the decomposition of polluted materials by microorganisms, and to eliminate microorganism load and toxic materials, chemicals should be introduced during pre-treatment. In order to treat a large amount of sludge produced from the chemicals, facilities must be expanded, this in turn increases operational costs.

### SUMMARY OF THE INVENTION

The present invention is made to solve these problems of the prior art, and it is an object of the present invention to provide an apparatus for purifying wastewater, which is simple and thus can be installed in a small site, does not use chemicals and thus produces little secondary pollutants, and is very effective in treating high density low-soluble materials.

It is another object of the present invention to provide an apparatus for purifying wastewater that can be installed in one end of a conventional wastewater purifying apparatus and improve efficiency of purifying wastewater.

### BRIEF DESCRIPTION OF THE DRAWINGS

FIG. 1 is a block diagram showing the outlined construction of the apparatus for purifying wastewater of the present invention.

FIG. 2 is a flow chart showing a preferable embodiment of the apparatus for purifying wastewater of the present invention.

10: flow equalization tank

20: transfer means

21, 21a, 23, 26, 51, 511, 515, 518, 519, 521, 523, 541, 541a: transfer pipe line 22, 22a, 51a, 51b: pump

25, 513: flow meter

30: reaction tank

32, 72: insulation wall

34: temperature sensor

36: oxidation-reduction measuring sensor

50: circulation treatment apparatus

52, 52a, 52b: Electrocoagulation and Electrolysis System 54, 54a, 54b: Electron Beam Plasma generator

56, 56a, 56b: Mass Transfer Accelerator

60: overflow duct

70: sedimentation tank

74, 76: discharge pipe line

516, 517: valve

520: venturi ejector

### DETAILED DESCRIPTION AND THE PREFERRED EMBODIMENTS

In order to achieve the above objects, the present invention provides an apparatus for purifying wastewater comprising:

a) a reaction tank which wastewater is introduced to and stays for a predetermined time;

b) a circulation treatment apparatus comprising

i) an electrolysis and electrocoagulation apparatus that is connected to a wastewater inlet of the reaction tank, where wastewater is continuously introduced and electrolyzed and electocoagulated; and

ii) a mass transfer accelerator that dissolves gases self-produced in the electrolysis and electrocoagulation apparatus in treated water discharged from the electrolysis and electrocoagulation apparatus; and

c) a sedimentation tank where treated water that overflows from the reaction tank stands, and from which the resultant precipitates are removed.

The circulation treatment apparatus b) may further comprise iii) a plasma generator.

The apparatus of the present invention can be utilized as an apparatus for purifying wastewater as it is, and in the case where the effluent water from existing wastewater treatment facility falls short of the standard quality, it can be additionally installed for retreating the effluent water.

In addition, the apparatus of the present invention can be adapted in a different ways. For example, the sequential construction of the apparatus for circulating wastewater can be optionally modified, and a plurality of the same equipment can be connected and used in series or in parallel.

The present invention will now be explained in more detail with reference to drawings.

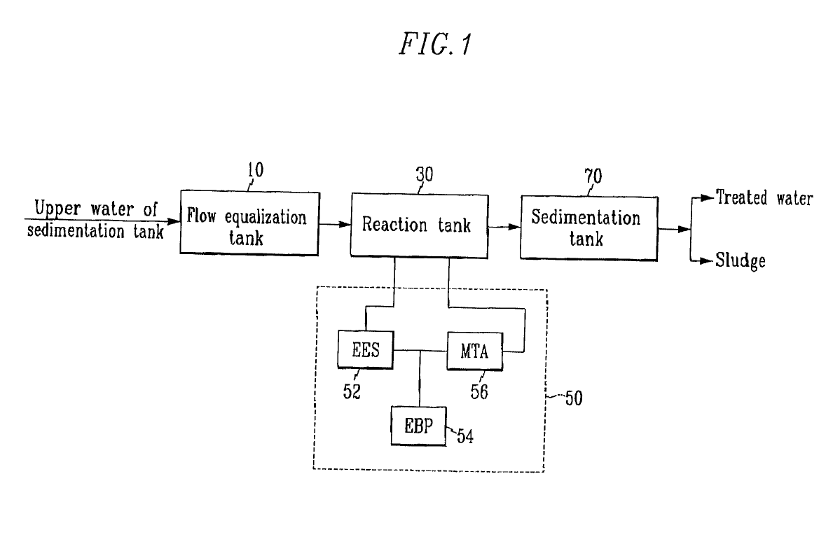

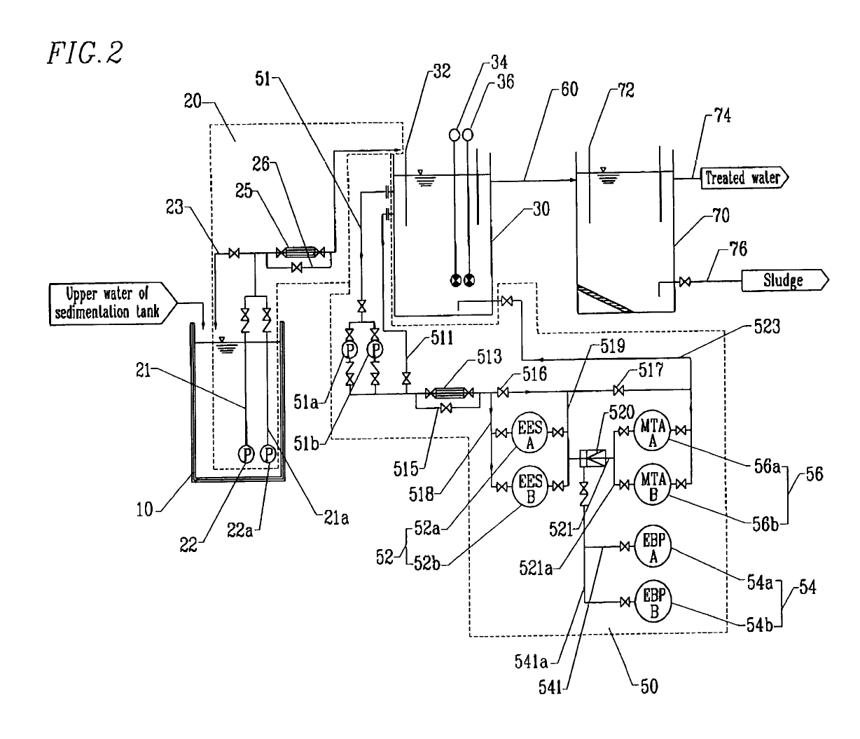

FIG. 1 is a block diagram showing the outlined construction of the apparatus of the present invention for purifying wastewater and FIG. 2 shows, in greater detail, the wastewater purifying apparatus shown in FIG. 1.

Referring to the figures, the apparatus of the present invention comprises a flow equalization tank (10) where the upper portion of water remaining in a sedimentation tank (i.e., after collected wastewater stands and, thus, generated sludge is removed) is introduced; a reaction tank (30) where a predetermined amount of treated water from the flow equalization tank (10) is introduced and stays for a predetermined time; a circulation treatment apparatus (50) that circulates wastewater staying in the reaction tank (30) and electrolyzes it; and a sedimentation tank (70) that precipitates the sludge of the treated water having overflowed from the reaction tank and removes the sludge.

The flow equalization tank (10) is equipped with a transfer means (20) for transferring wastewater to the reaction tank.

The transfer means (20) is equipped with a transfer pipe line (21) for connecting the flow equalization tank (10) with the reaction tank (30), a submerged pump (22) installed inside the flow equalization tank in one end of the transfer pipe line, and a flow meter (25) installed in the transfer pipe line.

In addition, the transfer means (20) is equipped with a spare submerged pump (22a) that is connected from a primary pipe line (21a) to the transfer pipe line (21), a secondary pipe line (26) connecting the pipe lines of both ends of a flow meter without passing the flow meter (25), and a tertiary pipe line (23) of which one end is connected to the transfer pipe line (21) before the flow meter (25) and the other end is connected to the flow equalization tank (10).

Each pipe line of the transfer means (20) is equipped with a valve for opening and closing the pipe line so that the flow of transferred wastewater can be optionally controlled.

The reaction tank (30) is equipped with an insulation wall (32) that is spaced from an inner wall and separates only the upper part, and the transfer pipe line (21) of the transfer means (20) passes between the insulating wall and the inner wall.

In addition, the reaction tank (30) is equipped with a circulation treatment apparatus (50), in which an electrolysis and electrocoagulation apparatus (EES) (52) and a mass transfer accelerator (MTA) (56) are sequentially connected to the reaction tank (30), and the MTA (56) is connected to the reaction tank (30) again so that wastewater circulates. An electron beam plasma generator (EBP) (54) is installed between the EES (52) and the MTA (56) by a venturi ejector (520).

Specifically, the circulation treatment apparatus (50) comprises a pipe line (51) in which wastewater in the reaction tank (30) is introduced by driving a submerged pump (51a), a flow meter (513), a pipe line (518), an EES (52), a pipe line (521), an MTA (56), and a pipe line (523)—in that order—for returning the treated water to the reaction tank (30).

In addition, the pipe line (521) is equipped with a venturi ejector for mixing plasma generated from the EBP (54), and a pipe line (511) is installed between the submerged pump (51a) on the pipe line (51) and the flow meter (513). The pipe line (511) returns treated water that bypasses the flow meter.

To selectively use a plurality of the EES (52a) (52b), MTA (56a) (56b) and EBP (54a) (54b), a plurality of pipe lines and valves (516) (517) are installed therebetween. Also, a spare submerged pump (51b) is installed in the event operation problems arise with the main pump (51a).

In addition, the reaction tank (30) is equipped with a temperature sensor (34) and an oxidation-reduction measuring sensor (36), etc., according to the measurement values of which the amount of introduced wastewater, electricity supplying amount, circulating amount, etc. are adequately controlled.

The sedimentation tank (70) is equipped with an insulation wall (72) having the same shape as those of the reaction tank. The reference numeral (60) indicates an overflow pipe line from the reaction tank (30) to the sedimentation tank (70), (74) indicates a pipe line for discharging treated water, and (76) indicates a pipe line for treating sludge sunk on the bottom of the sedimentation tank.

In the apparatus of the present invention, wastewater that is collected through various collection tubes firstly stays in a sedimentation tank, and the upper portion of remaining water (i.e., after removing generated suspensions and precipitates from the staying waste water) is introduced to a flow equalization tank (10), and a constant amount of waste water is sent to the reaction tank (30) again by transfer means (20).

The transfer means (20), driven by the submerged pump (21a), is equipped with a flow meter (25) and thus controls the amount of wastewater introduced to the reaction tank (30) at a constant level, and the spare submerged pump (21b) and the pipe line (26) is substitutionally operated when the flow meter (25) or the pump (21a) is not functioning properly.

The wastewater introduced in the reaction tank (30) is circulated by a circulation treatment apparatus (50). While in EES (52), O₂ and H₂ are produced from an anode and a cathode during electrolysis and HClO is produced when chlorine exists in wastewater. The products of electrolysis oxidize and reduce pollutant in wastewater and electrocoagulate and precipitate the intermediates, thereby electrolyzing and coagulating pollutant colloidal particles.

Then, the wastewater is combined with H⁺, H₂O₂, O₃, etc., which are generated in the EBP (54), through a venturi ejector (520), and the mixture of liquids and gases pass through the MTA (56) to become one phase aerated water which is circulated and introduced to the reaction tank (30) again. Since the MTA (56) accelerates mixing of gases and liquid to dissolve gases in liquid (wastewater), thereby maximizing contact area and time between reactants, i.e., gases and wastewater, it increases wastewater purifying efficiency and decrease incidental facilities.

The circulation treatment process is continuously conducted while wastewater stays in the reaction tank (30), during which time various pollutants contained in the wastewater are decomposed and coagulated and the quantity of dissolved oxygen in the wastewater increases.

Wastewater circulated from the MTA (56) is preferably spray treated to the bottom of the reaction tank (30) with a degree of pressure so as to prevent precipitates from sinking to the bottom of the reaction tank. The size of the reaction tank (30) does not need to be large since the treatment of wastewater is promptly progressed by the circulation treatment apparatus (50).

Since water treated in the reaction tank (30) is introduced to a sedimentation tank (70) by overflow and coagulated pollutants sink down therein, sludge lying on the bottom and the treated water of the upper part are separately collected, discharged, and retreated according to circumstances.

As explained, the wastewater purifying apparatus of the present invention can be modified according to the properties of the wastewater.

For example, in the case when the wastewater is land fill leakage or livestock waste water, the apparatus may comprise a primary reaction tank equipped with a storage tank, a primary sedimentation tank and a circulation treatment apparatus, a secondary reaction tank equipped with a secondary sedimentation tank and a circulation treatment apparatus, and a final sedimentation tank.

In addition, in the case when the quality of the effluent from an existing wastewater treatment facility is insufficient, a reaction tank and a sedimentation tank equipped with a circulation treatment apparatus of the present invention can be additionally installed downstream of the existing apparatus.

As explained, the apparatus of the present invention for purifying wastewater has a simple structure thereby decreasing the capacity needs of public structures, mechanical facilities, etc., and it can be installed in a small area, thereby maximizing the use of land. In addition, since a small amount of sludge is produced and a pre-treatment process for introducing chemicals is unnecessary, operational costs and the possibility of secondary pollution can decrease. Equally as important, however, is that the apparatus of the present invention provides a wastewater treating time of about 1 to 4 hours.

What is claimed is:

1. An apparatus for purifying wastewater comprising:
a) a reaction tank which wastewater is introduced to and stays for a predetermined time;
b) a circulation treatment apparatus comprising
i) an electrolysis and electrocoagulation apparatus that is connected to wastewater inlet of the reaction tank, where wastewater is continuously introduced, electrolyzed and electocoagulated; and
ii) a mass transfer accelerator that dissolves gases self-produced in the electrolysis and electrocoagulation apparatus in treated water discharged from the electrolysis and electrocoagulation apparatus; and
c) a sedimentation tank where treated water that overflows from the reaction tank stands, from which the resultant precipitates are removed.

2. The apparatus according to claim 1, further comprising a flow equalization tank for introducing a constant amount of wastewater into the reaction tank.

3. The apparatus according to claim 1, wherein the b) circulation treatment apparatus further comprise iii) a plasma generator.

4. The apparatus according to claim 3, wherein the iii) plasma generator is connected between the i) electrolysis and electrocoagulation apparatus and the ii) mass transfer accelerator.

5. The apparatus according to claim 1, wherein an insulation wall that is spaced from an inner wall of the reaction tank and separates the upper part of the reaction tank is installed in the reaction tank.

6. The apparatus according to claim 1, wherein a temperature sensor, oxidation-reduction measuring sensor or both of them is installed in the a) reaction tank.

7. A circulation treatment apparatus intended for use in a wastewater treatment apparatus, the circulation treatment apparatus comprising:
an electrolysis and electrocoagulation apparatus comprising an inlet, and an anode and cathode coupled to a power supply, the electrolysis and electrocoagulation apparatus continuously electrolyzing and electrocoagulating wastewater received through the inlet; and
a mass transfer accelerator comprising an inlet in fluid communication with the electrolysis and electrocoagulation apparatus, and an outlet, the mass transfer accelerator dissolving gases self-produced in the electrolysis and electrocoagulation apparatus before discharging wastewater through the outlet.

8. The circulation treatment apparatus of claim 7, further comprising:
a plasma generator in communication with the flow of wastewater through the circulation and treatment apparatus.

9. The circulation and treatment apparatus of claim 8, wherein the plasma generator is connected to the wastewater flow between the electrolysis and electrocoagulation apparatus and the mass transfer accelerator.

10. A method of treating wastewater comprising organic matter, the method comprising:
exposing wastewater to electrolytic conditions suitable to generate electrolysis products comprising H₂, O₂, or HClO; and
dissolving in the wastewater the electrolysis products generated during said exposing.

11. The method according to claim 10, further comprising:
introducing into the wastewater plasma products comprising H⁺, H₂O₂, or O₃.

12. The method according to claim 11, wherein said introducing is carried out after said exposing.

13. The method according to claim 11, wherein said introducing is carried out prior to said dissolving.

14. The method according to claim 13, wherein said dissolving further comprises dissolving the plasma products in the wastewater.

15. The method according to claim 10, wherein said dissolving is carried out in a mass transfer accelerator.
